(19) United States
(12) Patent Application Publication
(10) Pub. No.: US 2014/0174859 A1
(43) Pub. Date: Jun. 26, 2014

(54) SUSPENSION ARRANGEMENT AND GUIDE SHOE ARRANGEMENT FOR AN ELEVATOR

(71) Applicants: Janne MIKKONEN, Järvenpää (FI); Martti JUURIOKSA, Espoo (FI); Matti RÄSÄNEN, Hyvinkää (FI)

(72) Inventors: Janne MIKKONEN, Järvenpää (FI); Martti JUURIOKSA, Espoo (FI); Matti RÄSÄNEN, Hyvinkää (FI)

(73) Assignee: Kone Corporation, Helsinki (FI)

(21) Appl. No.: 14/193,444

(22) Filed: Feb. 28, 2014

Related U.S. Application Data
(63) Continuation of application No. PCT/FI2012/050809, filed on Aug. 24, 2012.

(30) Foreign Application Priority Data
Sep. 15, 2011 (FI) 20115902

(51) Int. Cl. B66B 11/08

(52) U.S. Cl. CPC B66B 11/08
USPC 187/266

(57) ABSTRACT

A suspension arrangement and guide shoe arrangement of an elevator, which arrangement comprises at least an elevator car and at least two compensating weights, which are for their part connected to support the elevator car by the aid of at least two suspension members, such as by the aid of ropes or belts, and also by the aid of diverting pulleys, and a hoisting machine provided with at least one traction sheave or corresponding, as well as at least two traction members, such as belts, ropes or chains, separate from the suspension members, which traction members are configured to transmit the rotational movement of the traction sheave into movement of the elevator car and of the compensating weights. There are at least four guide rails of the elevator car and they are fitted into an elevator hoistway symmetrically to each other in relation to the elevator car.

This application is a continuation of PCT International Application No. PCT/FI2012/050809 which has an International filing date of Aug. 24, 2012, and which claims priority to Finnish patent application number 20115902 filed Sep. 15, 2011, the entire contents of both which are incorporated herein by reference.

The object of the invention is a suspension arrangement and guide shoe arrangement for an elevator as defined in the preamble of claim 1.

In the suspension arrangement and guide shoe arrangement according to the invention the hoisting machine of the elevator is in the bottom part of the elevator hoistway and the suspension and traction of the elevator car are separated from each other. In this case the suspension members of the elevator car, such as the suspension ropes or suspension belts, and the traction members of the elevator car are separate from each other. This type of solution is well suited to buildings of different heights and even to elevators intended for extremely tall buildings, in which one problem is that when the location of the hoisting machine of the elevator is above, installation of the hoisting machine and peripheral structures of the elevator is awkward, expensive and even dangerous. The arrangement according to the invention is also suited to new elevators in low-rise buildings that previously had no elevator. In addition, the solution according to the invention is well suited to the modernization of old elevators.

Elevator solutions wherein the hoisting machine of the elevator is disposed on the base of the elevator hoistway, or close to the bottom part of the elevator hoistway, are known in the art. When the hoisting machine is disposed thus, the suspension ropes of the elevator cannot generally function simultaneously as the means intended for moving the elevator car, but instead separate traction ropes, traction belts or some other traction members are needed for moving the elevator car. One such prior-art solution is presented in international patent publication no. WO03/043927 A2, in which, inter alia, FIGS. 8 and 9 present suspension solutions wherein the hoisting machine of an elevator is disposed in the bottom part of the hoistway and the suspension ropes and traction ropes of the elevator car are different ropes. The elevator car and the counterweight are supported by the aid of a diverting pulley above, over which the suspension ropes fixed to the elevator car and to the counterweight pass around. Correspondingly, the moving of the elevator car is implemented with a separate toothed belt, which passes around the traction sheave of a hoisting machine below and is fixed from below between the elevator car and the counterweight. A problem in this solution is at least that the suspension of the elevator car is not in balance in relation to the center point of the elevator car. In this case additional stresses are exerted on the guide rails, support members and other hoistway structures, owing to which they must e.g. be dimensioned to be unnecessarily large. Additional stresses are produced e.g. when the load of the elevator car is not evenly distributed inside the elevator car. Another problem is that the solution is difficult to alter in relation to the layout, because one large counterweight takes so much hoistway space that flexible layouts cannot easily be used.

The aim of the present invention is to eliminate the aforementioned drawbacks and to achieve an inexpensive and easy-to-implement suspension arrangement and guide shoe arrangement, which combines the advantages of a hoisting machine disposed in the bottom part of the elevator hoistway and of flexible layout design, and which enables a type of new layout for an elevator with traction from below, by the aid of which layout the balance, productizability and space efficiency of the elevator can be improved. Another aim is to achieve a suspension arrangement and guide shoe arrangement of an elevator, which owing to its better balancing enables lighter and cheaper hoistway structures that have a longer life. The arrangement according to the invention is characterized by what is disclosed in the characterization part of claim 1. Other embodiments of the invention are characterized by what is disclosed in the other claims.

Some inventive embodiments are also discussed in the descriptive section of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment can also be applied in other embodiments. In addition it can be stated that at least some of the subordinate claims can, in at least some situations, be deemed to be inventive in their own right.

One advantage, among others, of the solution according to the invention is that by means of it symmetrical suspension, traction and also guidance of the vertical movement of the elevator car and compensating weights are made possible in an elevator in which the suspension ropes are separated from the traction members. In this case it is easy to keep the elevator car in balance all the time, in which case additional stresses are not exerted on the hoistway structures. The invention enables the use of two or more compensating weights, which can be smaller in size than one large counterweight or compensating weight. An advantage of small compensating weights is also that the solution according to the invention is space-efficient in both the width direction and the depth direction of the elevator hoistway. Yet another advantage is that by means of the arrangement according to the invention the rope arrangements and layouts of elevators can be diversified, which enables easier layout design. Another advantage is that owing to the smaller stresses the hoistway structures can be lighter and cheaper than in prior-art solutions. Another advantage is also that disposal of the traction members on both sides of the motor shaft of the hoisting machine balances the forces on the shaft better than in prior-art solutions. Another advantage is that all the diverting pulleys in the bottom part of the elevator hoistway can be disposed on almost the same plane in the vertical direction, in which case the machine structure is very shallow.

Another advantage is also the modularized machine structure. In this case from the viewpoint of production, three modules can be created, of which the motor module is always placed in the center of the hoistway, and extension modules provided with diverting pulleys are suitably disposed on both sides of it according to the size of the hoistway, and the extension modules are fixed into their position e.g. on the bottom ends of the guide rails. Another advantage is that when the traction is on the width center line of the hoistway, the bottom safety space can be made to fit in front of the motor module opposite the motor in the depth direction of the hoistway. One advantage is also that the guide rail forces are divided between four guide rails, instead of two, in which case smaller and cheaper guide rails can be used. Yet another advantage is that the whole solution is, owing to its symmetry, easily convertible to suit different hoistway sizes, in which case finding solutions viable for production is easier.

One inventive aspect in connection with the invention is guiding the elevator car and the compensating weight—or counterweight—on shared guide rails. In other words, the tracks of the elevator car and compensating weight/counterweight are determined with guide rails, at least one guide rail, preferably more, of which is common to both the elevator car and to the compensating weight/counterweight. In this way material savings and savings in installation work are achieved.

One advantageous manifestation of the invention is that the counterweight and/or elevator car is fixed to a traction member and/or to a suspension member at two fixing points that are between the guide shoes corresponding to the guide rails. The symmetrical placement of a fixing point between the guide rails results in smaller guide shoe forces.

In the following, the invention will be described in detail by the aid of one example of its embodiments with reference to the simplified and diagrammatic drawings attached, wherein

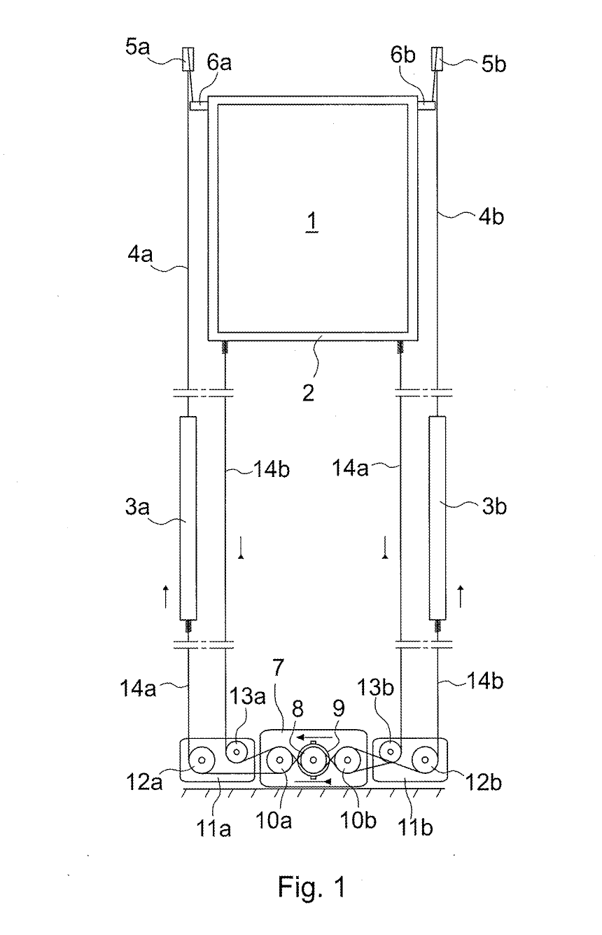

FIG. 1 presents a simplified and diagrammatic side view of one elevator arrangement according to the invention,

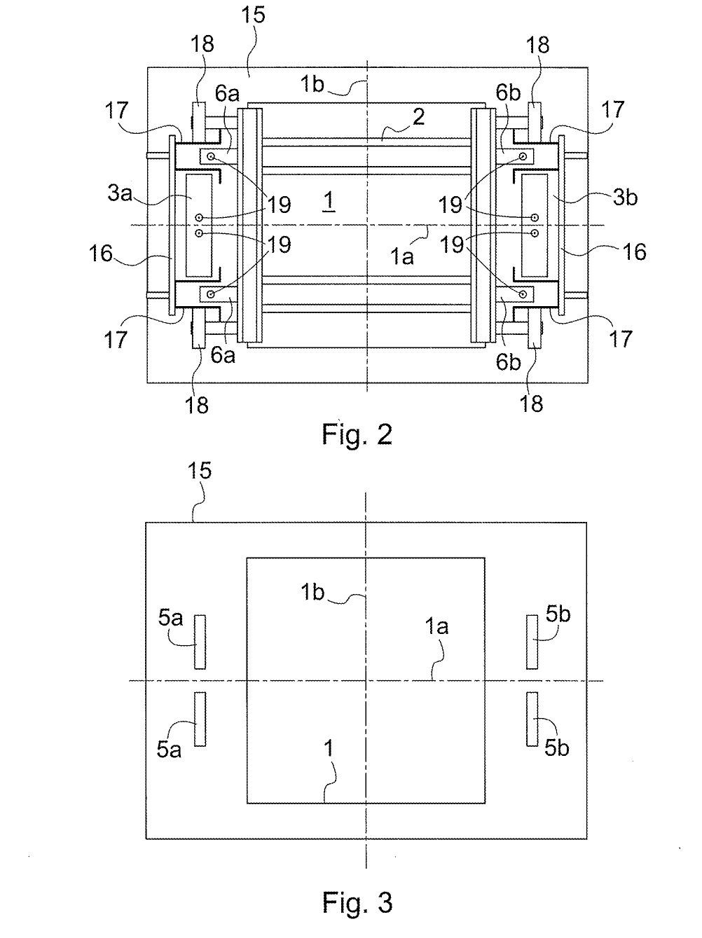

FIG. 2 presents a simplified and diagrammatic top view of an elevator arrangement according to FIG. 1,

FIG. 3 presents a top view of the top part of the elevator hoistway in an elevator arrangement according to FIG. 1,

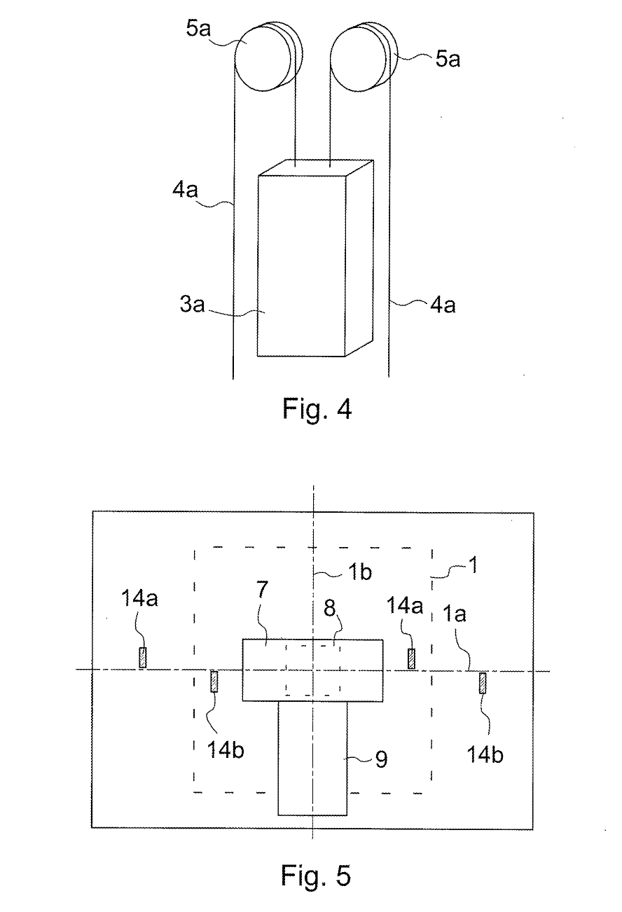

FIG. 4 presents an oblique side view of a suspension solution of a compensating weight in an elevator arrangement according to FIG. 1,

FIG. 5 presents a top view of the bottom part of the elevator hoistway in an elevator arrangement according to FIG. 1, and

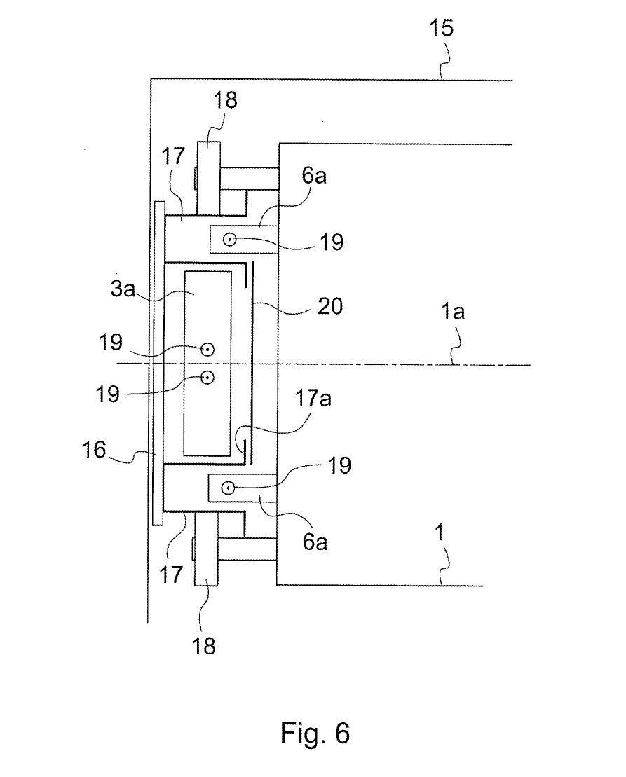

FIG. 6 presents a simplified, magnified and diagrammatic top view of the guide rail structures and guide shoe structures of an elevator arrangement according to FIG. 1.

To enable the arrangement according to the invention, the elevator arrangement comprises at least an elevator car 1 configured to move up and down in an elevator hoistway and at least one or more compensating weights 3a, 3b, which are for their part connected to support the elevator car by the aid of suspension members 4a, 4b, such as belts or ropes, and also by the aid of e.g. diverting pulleys 5a, 5b mounted on bearings in the top part of the elevator hoistway. In addition, the arrangement according to the invention comprises a hoisting machine 9, provided with at least one traction sheave 8 or corresponding and disposed in the bottom part of the elevator hoistway, and at least two or more traction members 14a, 14b, such as ropes or belts, that are fully separate from the suspension members 4a, 4b, which traction members are configured to transmit the rotational movement of the traction sheave 8 into linear movement of the elevator car 1 and of the compensating weights 3a, 3b. Characteristic to the solution according to the invention, and common to all the different embodiments of the invention, is that each compensating weight 3a, 3b, or in some cases more than two compensating weights, is connected, by the aid of its own traction member 14a, 14b provided with e.g. essentially spring tensioning or constant-force tensioning, to most preferably one and the same hoisting machine 9.

FIG. 1 presents a simplified and diagrammatic side view of one elevator arrangement applicable to the solution according to the invention. The elevator arrangement according to FIG. 1 comprises two compensating weights 3a and 3b functioning as counterweights and disposed symmetrically on different sides of the elevator car 1, both of which compensating weights are connected by means of suspension members 4a and 4b to a car sling 2 fitted around the elevator car 1. One suspension member 4a, 4b can be e.g. just an individual rope, belt or chain, or it can be composed of a number of parallel members, e.g. hoisting ropes. The suspension members 4a, 4b are e.g. steel wire ropes or belts and they are fixed at their first ends to the top part of the compensating weights 3a and 3b, from where they are led upwards to pass around the top of the diverting pulleys 5a and 5b fitted in the top part of the elevator hoistway, from where onwards down to the fixing means 6a and 6b on the top part of the car sling 2, to which fixing means the suspension members 4a, 4b are fixed at their second ends.

A motor module 7 is fitted in the bottom part of the elevator hoistway, which motor module comprises at least a hoisting machine 9 arranged to move the elevator car 1 and provided with a traction sheave 8, as well as two diverting pulleys 10a and 10b. The arrangement also comprises two extension modules 11a and 11b, which are fitted at the edges of the elevator hoistway on opposite sides of the motor module 7 to each other. Both extension modules comprise at least two diverting pulleys, which are arranged to guide the traction members 14a and 14b.

The first traction member 14a is fixed at its first end to the bottom part of the first compensating weight 3a, from where it is led down to pass around the bottom of the first diverting pulley 12a of the first extension module 11a, from where onwards under the first diverting pulley 10a of the motor module 7, after which over the traction sheave 8. From the traction sheave 8 the first traction member 14a is led to pass around the bottom of the second diverting pulley 10b of the motor module 7, from where onwards under the second diverting pulley 13b of the second extension module 11b, after passing around the bottom of which diverting pulley 13b the traction member 14a is led up to the car sling 2, to the bottom part of which the first traction member 14a is fixed e.g. via a fixing means provided with e.g. spring tensioning or constant-force tensioning.

The second traction member 14b is, for its part, fixed at its first end to the bottom part of the second compensating weight 3b, from where it is led down to pass around the bottom of the first diverting pulley 12b of the second extension module 11b, from where onwards over the second diverting pulley 10b of the motor module 7, after which under the traction sheave 8. From the traction sheave 8 the second traction member 14b is led to pass around the top of the first diverting pulley 13a of the motor module 7, from where onwards under the second diverting pulley 13a of the first extension module 11a, after passing around the bottom of which diverting pulley 13a the traction member 14b is led up to the car sling 2, to the bottom part of which the second traction member 14b is fixed e.g. via a fixing means provided with e.g. spring tensioning or constant-force tensioning.

In the situation according to FIG. 1, the traction sheave 8 rotates in the direction of the arrows drawn above and below the traction sheave, in which case the elevator car 1 moves downwards and the compensating weights 3a and 3b move upwards.

FIG. 2 presents a simplified and diagrammatic top view of an elevator arrangement according to FIG. 1. The elevator car 1 is fitted inside the car sling 2. Essentially vertical guide rails 17 are fixed by the aid of clamps 16 to the side walls of the elevator hoistway 15, guided by which guide rails the elevator car 1 is arranged to travel up and own in the hoistway 15. On both sides of the elevator car 1 are two guide rails 17 that are essentially similar to each other and are fitted symmetrically with respect to each other and to the elevator car 1. In this case the guide rails 17 are disposed symmetrically as viewed from above in relation both to the depth center line 1a of the elevator car running through the center point of the elevator car 1 and to the width center line 1b of the elevator car running through the center point of the elevator car 1.

Compensating weights 3a, 3b are fitted between the guide rails 17 on both sides of the elevator car 1, at least one compensating weight each side of the elevator car 1, which compensating weights 3a, 3b are configured to travel in the hoistway 15 resting on the first outer surfaces, which are opposite each other, of the guide rails 17. In FIG. 2 the compensating weights 3a, 3b are, however, for the sake of clarity presented as slightly detached from the aforementioned outer surfaces, which are opposite to each other, of the guide rails 17. Correspondingly the elevator car 1 is configured to rest, by the aid of roller guide shoes 18 fixed to the car sling 2, on the second outer surfaces of the guide rails 17, which surfaces point away from each other.

The suspension members 4a, 4b of the elevator car 1 are arranged to be fixed at their first ends to the top parts of the compensating weights 3a, 3b and at their second ends to the fixing means 6a, 6b on the car sling 2. The fixing points of the suspension members 4a, 4b are marked in the figure with the number 19. As is seen from FIG. 2, the suspension and the guidance of the vertical movement of the elevator car 1 is implemented symmetrically with respect to the center lines 1a and 1b, in which case no additional stresses or strains are exerted e.g. on the guide rails 17 and other hoistway structures.

FIG. 3 presents a simplified and diagrammatic top view of the top part of the elevator hoistway 15. Diverting pulleys 5a and 5b are fitted in the top part of the elevator hoistway 15 on opposite sides of the elevator car 1 in the lateral direction. In this embodiment on the first side of the elevator car 1 above the elevator car 1 and on the side of the travel profile of the elevator car 1 are two first diverting pulleys 5a symmetrically on different sides of the depth center line 1a of the elevator car. Correspondingly, on the second side of the elevator car 1 above the elevator car 1 and on the side of the travel profile of the elevator car 1 are two second diverting pulleys 5b symmetrically on different sides of the depth center line 1a of the elevator car 1. In addition the diverting pulleys 5a and 5b are disposed symmetrically to each other in relation to the width center line 1b of the elevator car 1. The suspension members 4a, 4b of the elevator car 1 are led over the diverting pulleys 5a, 5b from the compensating weights 3a, 3b to the elevator car 1, as is already described in the descriptive part of FIG. 1.

FIG. 4 presents an oblique view from the side and top of a suspension arrangement of the compensating weights of the elevator arrangement presented above. FIG. 4 presents only the first compensating weight 3a, because the second compensating weight 3b is suspended in the same way. In the situation according to FIG. 1, the elevator car 1 is in its bottom position and the compensating weights 3a and 3b are in their top position near the diverting pulleys 5a and 5b. The first suspension members 4a, which are thus at least two belts, ropes or two pluralities of parallel ropes, leaving from the compensating weight 3a each pass around the top of their own diverting pulley 5a and then descend to their fixing points 19 on the elevator car 1. The suspension members 4b on the second side of the elevator car 1 are suspended in a corresponding manner.

FIG. 5 presents a simplified and diagrammatic top view of the bottom part of the elevator hoistway 15. For the sake of clarity, in FIG. 5 the diverting pulleys in the bottom part of the hoistway are not presented, and the traction members 14a and 14b are presented as cross-sections. The traction members 14a and 14b are preferably e.g. toothed belts, which are configured to travel a part of the distance parallel with each other and symmetrically to each other on both sides of the depth center line 1a of the elevator car 1. In the arrangement according to FIG. 5 the traction member 14a is disposed on a first side of the depth center line 1a of the elevator car 1 and the traction member 14b is disposed on a second side of the depth center line 1a of the elevator car 1. In addition, the horizontal distances of the traction members 14a and 14b are symmetrically disposed from the width center line 1b of the elevator car 1.

The toothed contact surface of the traction sheave 8 is so wide that both the traction members 14a, 14b fit side-by-side onto the contact surface of the traction sheave 8 without interfering with each other. In this way one and the same hoisting machine 9 and also one and the same traction sheave 8 give to both the traction members 14a, 14b a force producing linear movement of the elevator car 1 and of the compensating weights 3a, 3b.

FIG. 6 presents a simplified, magnified and diagrammatic top view of the guide rail structures and guide shoe structures of an elevator arrangement according to FIG. 1, the structure and operation of which have been described already in conjunction with FIG. 2. For the sake of clarity, in FIG. 6 the clamps 16 are presented slightly detached from the side wall of the elevator hoistway 15, although in reality they are attached to the side wall. The guide rail 17 of the elevator car 1 is in its cross-section essentially a U-shaped beam, which opens towards the elevator car 1. In this case it has been possible to fit the fixing means 6a, 6b of the suspension members 4a, 4b on the car sling 2, and the fixing points 19 of the suspension members 4a, 4b in them, inside the web of the guide rail 17, in which case it has been possible to utilize the space in the width direction of the elevator hoistway 15 better. The compensating weights 3a and 3b disposed between the guide rails 17 are configured to travel in the hoistway 15 resting on the first outer surfaces, which are opposite each other, of the web of the guide rails 17. For the sake of clarity, the compensating weight 3a is presented in FIG. 6 slightly detached from the aforementioned outer surface of the guide rails 17. Correspondingly the elevator car 1 is configured to rest, by the aid of roller guide shoes 18 fixed to the car sling 2, on the second outer surfaces of the guide rails 17, which surfaces point away from each other.

Flanges, turned outwards from the web of the guide rail at a right angle with respect to the web of the guide rail 17, are additionally on the guide rail 17 on the side of the elevator car 1, of which the flanges 17a that point towards each other are configured as a fixing surface for an enclosure board 20, with which the compensating weight 3a, 3b is enclosed in its own enclosure. Good enclosing reduces the noise disturbance when, inter alia, the elevator car 1 and the compensating weights 3a, 3b meet each other in the elevator hoistway.

It is further characteristic to the arrangement according to the invention that the positioning point of the diverting pulleys 5a, 5b disposed in the top clearance of the elevator hoistway 15 is configured such that the elevator car 1 can rise past the diverting pulleys 5a, 5b in the top end of the elevator hoistway 15 right to the top end of the elevator hoistway 15. In this way the most space-efficient layout solution possible is also achieved in the top end of the elevator hoistway 15.

It is obvious to the person skilled in the art that the invention is not limited solely to the examples described above, but that it may be varied within the scope of the claims presented below. Thus, for example, the suspension solutions can also be different to what is presented above.

It is further obvious to the person skilled in the art that the location of the hoisting machine can be elsewhere than what is presented above. The hoisting machine can be on the base of the elevator hoistway, or close to the base, but also on some side of the elevator hoistway and also in the top part of the elevator hoistway.

It is also obvious to the person skilled in the art that the number of compensating weights can also be greater than two. There can be e.g. three, four, six, eight, ten or even more compensating weights disposed in a different manner.

1. Suspension arrangement and guide shoe arrangement of an elevator, which arrangement comprises at least an elevator car configured to move up and down in an elevator hoistway guided by guide rails and at least two compensating weights, which are for their part connected to support the elevator car by the aid of at least two suspension members, such as ropes or belts, and also by the aid of diverting pulleys, and a hoisting machine provided with at least one traction sheave or corresponding, as well as at least two traction members, such as belts, ropes or chains, separate from the suspension members, which traction members are configured to transmit the rotational movement of the traction sheave into movement of the elevator car and of the compensating weights, wherein there are at least four guide rails of the elevator car and they fitted into the elevator hoistway symmetrically to each other in relation to the elevator car.

2. Suspension arrangement and guide shoe arrangement of an elevator according to claim 1, wherein the guide rails of the elevator car are disposed symmetrically in relation to the depth center line and the width center line of the elevator car.

3. Suspension arrangement and guide shoe arrangement of an elevator according to claim 1, wherein there are two guide rails of the elevator car on both sides of the elevator car.

4. Suspension arrangement and guide shoe arrangement of an elevator according to claim 1, wherein the arrangement comprises two essentially similar compensating weights, one on each side of the elevator car, and in that both compensating weights are suspended in connection with the elevator car with two separate suspension members, which are disposed symmetrically to each other on different sides of the depth center line of the elevator car.

5. Suspension arrangement and guide shoe arrangement of an elevator according to claim 1, wherein the compensating weights are disposed symmetrically to each other on different sides of the depth center line and of the width center line of the elevator car.

6. Suspension arrangement and guide shoe arrangement of an elevator according to claim 1, wherein in the top part of the elevator hoistway are two diverting pulleys for each compensating weight, one for each suspension member of a compensating weight.

7. Suspension arrangement and guide shoe arrangement of an elevator according to claim 1, wherein the traction members in the bottom part of the elevator hoistway are configured to travel at least a part of the distance parallel with each other and symmetrically to each other on different sides of the depth center line of the elevator car.

8. Suspension arrangement and guide shoe arrangement of an elevator according to claim 1, wherein the horizontal distances of the vertical parts of the traction members from the width center line of the elevator car are symmetrically disposed to each other.

9. Suspension arrangement and guide shoe arrangement of an elevator according to claim 1, wherein the compensating weights are disposed in an enclosure, two walls of which are comprised of guide rails, which are on different sides to each other of the depth center line of the elevator car.

10. Suspension arrangement and guide shoe arrangement of an elevator according to claim 1, wherein at least one of the guide rails is common to the track both of the elevator car and of the compensating weight/counterweight.

11. Suspension arrangement and guide shoe arrangement of an elevator according to claim 1, wherein the fixing point of a traction member and/or of a suspension member to be fixed to the counterweight and to the elevator car is disposed symmetrically between the two guide rails guiding said counterweight or elevator car, at least on one of these, either the counterweight or the elevator car.
